(19) United States
(12) Patent Application Publication
(10) Pub. No.: US 2019/0005387 A1
(43) Pub. Date: Jan. 3, 2019

(54) METHOD AND SYSTEM FOR IMPLEMENTATION OF ATTENTION MECHANISM IN ARTIFICIAL NEURAL NETWORKS

(71) Applicant: ANTS TECHNOLOGY (HK) LIMITED, HONG KONG (HK)

(72) Inventors: Ilya BLAYVAS, Rehovot (IL); Alex ROSEN, Ramat Gan (IL); Pavel NOSKO, Yavne (IL); Gal PERETS, Mazkeret Batya (IL); Ron FRIDENTAl, Shoham (IL)

(21) Appl. No.: 15/640,548

(22) Filed: Jul. 2, 2017

(51) Int. Cl. G06N 3/08; G06N 3/04

(52) U.S. Cl. CPC G06N 3/08; G06N 3/04

(57) ABSTRACT

A system and method for implementation of attention mechanism in artificial neural networks, the method comprising: receiving sensor data from at least one sensor sensing properties of an environment, classifying the received data by a multi-regional neural network, wherein each region of the network is trained to classify sensor data with a different property of the environment, and wherein each region has an individually adjustable contribution to the classification, calculating based on the classification a current environment state including at least one property of the environment, and based on the at least one property, selecting corresponding regions of the network and adjusting contribution of the selected regions to the classification.

### FIELD OF THE INVENTION

The present disclosure generally relates to artificial neural networks, and more specifically to learning methods of artificial neural networks.

### BACKGROUND

Artificial neural networks became the backbone engine in computer vision, voice recognition and other applications of artificial intelligence and pattern recognition. Rapid increase of available computation power allows to tackle problems of higher complexity, which in turn requires novel approaches in network architectures, and algorithms.

Deep Neural Networks (DNN) is a class of machine learning algorithms visualized as cascades of several layers of neurons with connections between them. Each neuron calculates its output value based on the values of input neurons fed through connections, multiplied by certain weights, summarized, offset by some number and transformed by non-linear function. Various types of DNN architectures, including, among many others, the Convolutional Neural Networks (CNN) and Recurrent Neural Networks (RNN); and application domains including Computer Vision, Speech Recognition and Natural Language Processing (NLP) had been demonstrated [LeCun 2015], [B1, B2].

In some DNN systems, the neural network is trained to recognize objects from each class by training over a large training set, containing thousands or millions of annotated sample images with marked object positions and class attributions. The network can be perceived as a mapping from the signal space to the object space, embodied as a graph of vertices and directed edges connecting them. The vertices are organized in layers, where the input layer receives an input signal, such as an image frame from an input video sequence. The vertices in the intermediate layers receive the values of the vertices in the prior layers via weighted edges, i.e. multiplied by the edge value, summarize the values, and transfer them through a transfer function towards the output edges. The amount of adjustable weights in a neural network can be counted from many thousands to billions. The mapping of the network is adjusted by tuning the weights during the network training, until the trained network yields the corresponding ground truth outputs in response to being fed with the training input.

In some neural network training procedures, the weights are adjusted to minimize as a so-called loss function, where the loss function is defined to be big on erroneous network answers, and small on the correct answers. For example, the network response to an input training sample is calculated and compared to a ground truth corresponding to the sample. If the network errs, the error is calculated and back-propagated along the network, and weights are updated according to a gradient of weight adaptations calculated for minimizing the error. Since changing the weight to fit the network to a particular sample may move it away from an optimal response to other samples, the process is repeated many times, with small and ever decreasing update rate. The network is trained over the entire training set repeatedly.

The training objective is to create an artificial neural network that outputs correct responses to unseen inputs, and not just to the training set. The ability of the network to yield correct responses to the unseen examples is called a generalization ability of the network. In some systems, in order to improve the generalization of the network, the loss function is enhanced with suitable regularization terms. Various network architectures, training methods, network topologies, transfer functions, loss functions, regularization methods, training speeds, propagation of errors and/or training set batching and augmentation, have so been developed and researched in attempt to improve the generalization ability neural networks.

Usually, a loss function L is defined as:

$$L = {\sum }_{j} l ( {p}_{j}^{k} , {a}_{j}^{k} )$$

i.e. a sum over all the nodes of the neural network, here indexed by j, of the non-decreasing function of distance between the expected value aⱼ^{k} and predicted answer pⱼ^{k} for the object belonging to the class k.

As mentioned herein, the loss function may also include regularization terms, favoring robust generalization by the network to improve prediction of the unseen examples.

### REFERENCES

1. [LeCun 2015] Deep Learning; Y. LeCun, Y. Bengio, G. Hinton; Nature, 2015
2. [B1] https://en.wikipedia.org/wiki/artificial_neural_network
3. [B2] https://en.wikipedia.org/wiki/deep_learning

### SUMMARY

In one aspect of some embodiments of the present invention, there is provided a method for implementation of attention mechanism in artificial neural networks, the method including: receiving sensor data from at least one sensor sensing properties of an environment, classifying the received data by a multi-regional neural network, wherein each region of the network is trained to classify sensor data with a different property of the environment, and wherein each region has an individually adjustable contribution to the classification, calculating based on the classification a current environment state including at least one property of the environment, and based on the at least one property, selecting corresponding regions of the network and adjusting contribution of the selected regions to the classification.

Optionally, altering contribution of the selected regions is by applying a weight coefficient to an output value of a node of the network, according to a location of the node so within the network.

Optionally, altering contribution of the selected regions is by activating a region relating to a classification option selected based on the at least one property.

Optionally, altering contribution of the selected regions is by configuring the classification to classify by relevant combinations of network regions.

Optionally, in each of the neural network regions some of the network nodes are unique to that region and some network nodes are common to more than one of the neural network regions.

Optionally, the neural network regions have various sizes and/or structures.

Optionally, the method includes training the neural network to generate a multi-so regional neural network, by a loss function including a member depending on a classification parameter and a location of a network node in the neural network.

Optionally, the sensor data comprises at least one of image data, depth data and sound data, and wherein the at least one property is an object and/or a condition of the environment.

In another aspect of some embodiments of the present invention, there is provided a system for implementation of attention mechanism in artificial neural networks, the system including at least one sensor configured to sense properties of an environment, and a processor configured to carry out code instructions for receiving sensor data from the at least one sensor, classifying the received data by a multi-regional neural network, wherein each too region of the network is trained to classify sensor data with a different property of the environment, and wherein each region has an individually adjustable contribution to the classification, calculating based on the classification of a current environment state including at least one property of the environment, and based on the at least one property, selecting corresponding regions of the network and adjusting contribution of the selected regions to the classification.

Optionally, the processor is configured to alter contribution of the selected regions by applying a weight coefficient to an output value of a node of the network, according to a location of the node within the network.

Optionally, the processor is configured to alter contribution of the selected regions by activating a region relating to a classification option selected based on the at least one property.

Optionally, the processor is configured to alter contribution of the selected regions by configuring the classification to classify by relevant combinations of network regions.

Optionally, in each of the neural network regions some of the network nodes are unique to that region and some network nodes are common to more than one of the neural network regions.

Optionally, the neural network regions have various sizes and/or structures.

Optionally, the processor is configured to train the neural network to generate a multi-regional neural network, by a loss function including a member depending on a classification parameter and a location of a network node in the neural network.

Optionally, the sensor data comprises at least one of image data, depth data and sound data, and wherein the at least one property is an object and/or a condition of the environment.

### BRIEF DESCRIPTION OF THE DRAWINGS

Some non-limiting exemplary embodiments or features of the disclosed subject matter are illustrated in the following drawings.

In the drawings:

FIG. 1 is a schematic illustration of a system for implementation of attention mechanism in an artificial neural network, according to some embodiments of the present invention;

FIG. 2 is a schematic flowchart illustrating a method for implementing an attention mechanism in an artificial neural network, according to some embodiments of the present invention;

FIG. 3 is a schematic illustration of an attention mechanism for controlling a neural network classification engine, according to some embodiments of the present invention; and

FIG. 4 is a schematic illustration of a neural network classification engine 300, for example implemented in a recognition engine, according to some embodiments of the present invention.

With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

### DETAILED DESCRIPTION

Some embodiments of the present invention provide a system and method for region differentiated functionality and attention mechanisms in Artificial Neural Networks (ANN), for example Deep ANN (DNN).

The provided system and method may enable more brain-like behavior of ANN-operated systems. This is enabled by using attention focus to deal more efficiently with tasks such as search, recognition, detection and/or analysis.

In some embodiments of the present invention, in order to implement an attention mechanism into ANN, the ANN is designed and trained to allow region-differentiated functionality, and controlled in a way allowing selection and enhancement of certain regions, thus improving the required functionality.

For example, for object recognition from video, the ANN structure may be divided into blocks, cross-trained for certain conditions and for detection of certain types of objects. In order to recognize an object, the object detection process may be configured by an attention mechanism engine, by utilization of the appropriate blocks from the structure, which pertain to the relevant conditions and types of objects.

In some embodiments, the system executes a specially constructed loss function that causes training of various blocks, regions and/or subsets of vertices of the ANN as responsible for different functionalities, such as recognition of different classes of objects. The various blocks, regions and/or subsets of vertices may be dynamically enhanced and/or inhibited by the attention mechanism engine.

Some embodiments of the present invention may include a system, a method, and/or a computer program product. The computer program product may include a tangible non-transitory computer readable storage medium (or media) having computer readable program instructions thereon for causing a processor to carry out aspects of the present iso invention. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including any object oriented programming language and/or conventional procedural programming languages.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

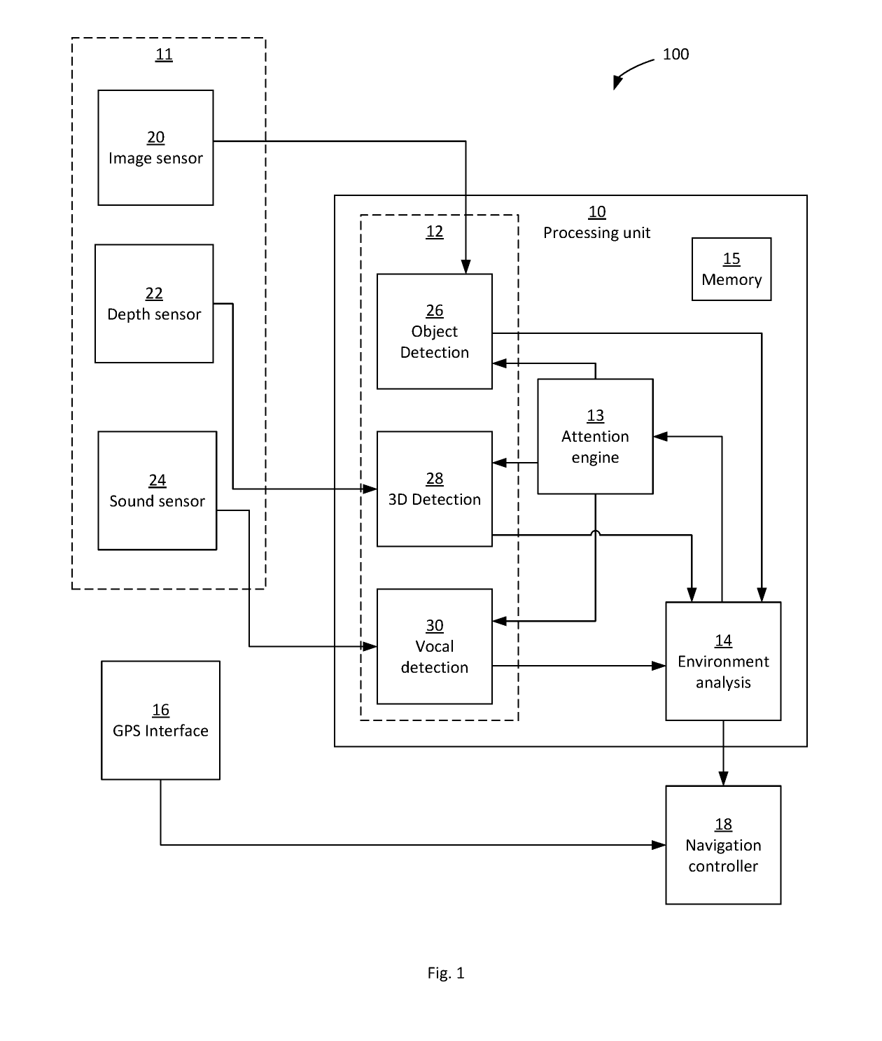

Reference is now made to FIG. 1, which is a schematic illustration of a system 100 for implementing an attention mechanism in an artificial neural network, according to some embodiments of the present invention. System 100 may be implemented in an autonomic navigation system, such as in cars, aerial vehicles, domestic robots and/or any other suitable autonomic machine.

System 100 may include a processing unit 10, sensors 11 and a navigation controller 18. In some embodiments, system 100 may include a positioning system interface 16. Processing unit 10 may include at least one hardware processor and a non-transitory memory 15. Non-transitory memory 15 may store code instructions executable by the at least one hardware processors. When executed, the code instructions may cause the at least one hardware processor to perform the methods described herein.

Sensors 11 may include, for example, one or more video cameras, directed microphones, a Global Positioning System (GPS) sensor, a speed sensor and/or a depth sensor such as such as a Radio Detection and Ranging (RADAR) sensor, Light Detection and Ranging (LIDAR) sensor, a laser scanner and/or a stereo pair of video cameras, and/or any other suitable sensor. In some embodiments of the present invention, sensors 11 may include an image sensor 20, a depth sensor 22, a sound sensor 24 and/or any other suitable sensor that may facilitate acquiring knowledge about a current environment and/or orientation. Image sensor 20 may include a video camera and/or any other image sensing device. Depth sensor 22 may include a three-dimensional (3D) scanning device such as a RADAR system. Sound sensor 24 may include, for example, a set of directional microphones and/or any other suitable sound detection device enabling identification of a direction from which sound is arriving.

Processing unit 10 may include and/or execute recognition and detection engines 12, attention engine 13 and high-level environment analysis engine 14. In some embodiments, recognition and detection engines 12 include object recognition engine 26, 3D recognition engine 28, audio and speech recognition engine 30 and/or any other suitable recognition and/or detection engine for detection and recognition of properties of a current environment and/or orientation. Recognition and detection engines 12 and/or high-level situation and environment analysis engine 14 may include, execute and/or operate by ANN.

In some embodiments of the present invention, recognition engines 12 and/or high level analysis engine 14 may execute a DNN algorithm. As mentioned herein, system 100 may be implemented in an autonomic navigation system, such as in cars, aerial vehicles, domestic robots and/or any other suitable autonomic machine. Such systems may receive a large amount of data in streams receives from the various sensors and may be required to recognize a state out of a large number of possible states and combinations thereof, and/or to choose a task to perform and/or an order for performing multiple tasks out of many possible tasks.

For example, in a car autonomic navigation system, system 100 needs to be able to detect and/or recognize various possible objects and/or obstacles such as pedestrians, cars, motorcycles, tracks, traffic signs, traffic lights, road lanes, roadside and/or other objects and/or obstacles, and/or conditions such as illumination, visibility and/or road conditions. For example, system 100 needs to be able to identify and/or interpret traffic signs, traffic lights and/or road lanes, to find a preferable route to a target destination, to identify a current road situation, to decide on a proper action, and/or to generate corresponding commands to the vehicle controls.

In some embodiments of the present invention, system 100 is configured to robustly operate in various illumination, environment conditions and road situations. High-level situation and environment analysis engine 14 infers the environment conditions and road situation, and instructs attention engine 13 accordingly. Attention engine tunes the pattern recognition engines 12, for example object recognition engine 26, 3D recognition engine 28 and audio and speech recognition engine 30, to enhance the detection of certain objects, or enhance operation in certain conditions, in accordance to the inferred situation and environment. For speech recognition applications, attention engine 13 may tune audio and speech recognition engine 30 for detection, for example, of certain languages, or certain accents.

In case of autonomous vehicle navigation, the attention mechanism may include tuning of sensors 11 and/or recognition engines 12 by attention engine 13, for example, for night or rainy conditions, for children detection near the school, and/or for winter clothes detection in winter.

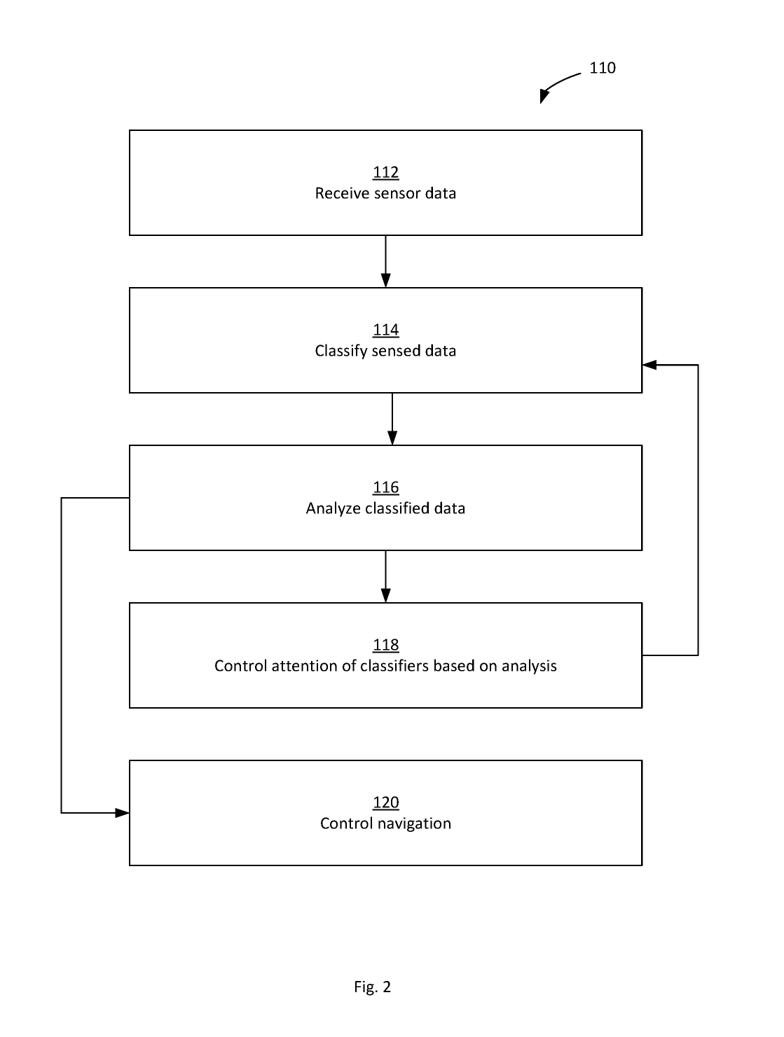

Further reference is now made to FIG. 2, which is a schematic flowchart illustrating a method 110 for implementing an attention mechanism in an artificial neural network, according to some embodiments of the present invention.

As indicated in block 112, processing unit 10 may receive sensor data from sensors 11, for example streams of image data, depth data, sound data and/or any other suitable sensor data. As indicated in block 114, processing unit 10 may classify the sensed data, e.g. process the received data and recognize properties of a current environment and orientation, for example by detection and/or recognition engines 12. For example, object recognition engine 26 analyses image data received from image sensor 20 and detects and/or recognizes in the image data objects and/or other visual properties, such as illumination and/or visibility conditions. For example, 3D recognition engine 28 analyses depth data from depth sensor 22 and generates a 3D map of a current environment and/or orientation, and/or may facilitate recognition of objects detected by engine 26. For example, vocal recognition engine 30 processes the received sound data and recognizes audio signals, such as traffic noise, and/or may facilitate recognition of the sources of the audio signals, for example within the image and/or 3D streams and/or objects recognized by engine 26.

As indicated in block 116, processing unit 10 may analyze the classified data, for example perform a high level analysis of a current state of the environment by environment high-level analysis engine 14. For example, high level engine 14 receives information about detected objects, depth and/or sounds from recognition engines 12, and calculates a current environment state, for example a current map of objects and/or properties of the environment, based on the received information. High level analysis engine 14 may calculate a state of an environment by combining information from the various recognition engine, such as further recognition and/or identification of objects detected by object recognition engine 26, based on information generated by 3D recognition engine 28 and/or vocal recognition engine 30. For example, in case system 100 is implemented in an autonomic vehicle, high level analysis engine 14 may analyze the road situation, taking into account, for example, other vehicles, obstacles, traffic signs, illumination, visibility conditions and/or any other information that may be generated by recognition engines 12. Based on the high level analysis, processing unit 10 may control navigation of an autonomous machine, as indicated in block 120, for example by navigation controller 18, for example assisted by GPS interface 16.

As indicated in block 118, based on the calculated current environment state, processing unit 10 may control attention focus of the classifiers, e.g. recognition engines 12. For example, based on the high level analysis, attention engine 13 may recognize certain regions and/or properties of the environment that requires enhanced attention, and send commands to recognition engines 12 to focus on the recognized attention-requiring regions and/or properties. For example, in a case of an autonomic vehicle system, attention engine 13 may adapt recognition engines 12 to varying road situations. For example, in case high level analysis engine 14 recognizes a ‘children on road’ traffic sign, attention engine 13 may instruct recognition engines 12 to focus on and/or amplify sensitivity of pedestrian detection, and possibly to specifically focus on and/or amplify sensitivity of children pedestrian detection.

For example, in case high level analysis engine 14 recognizes winter and/or snow conditions, attention engine 13 may instruct recognition engines 12, for example, to focus on and/or amplify sensitivity of detection of cars in harsh weather conditions or specifically snow conditions and/or pedestrians in warm winter clothes.

In turn, recognition engines 12 may generate information by performing detection and/or recognition while focusing on regions and/or properties according to the received commands, and provide the generated information to high level analysis engine 14, and so on.

In some embodiments of the present invention, attention engine 13 may alter the contribution of a node according to a location of the node in the neural network. For example, attention engine 13 may multiply an output value of node i by coefficient cᵢ, wherein i is the location index of the node location within the network. For example, when high level analysis engine 14 recognizes a situation that favors the detection of objects from a certain class, the corresponding coefficients to a relevant region of the network is amplified, while the complementary regions may be attenuated, for example for normalization purposes.

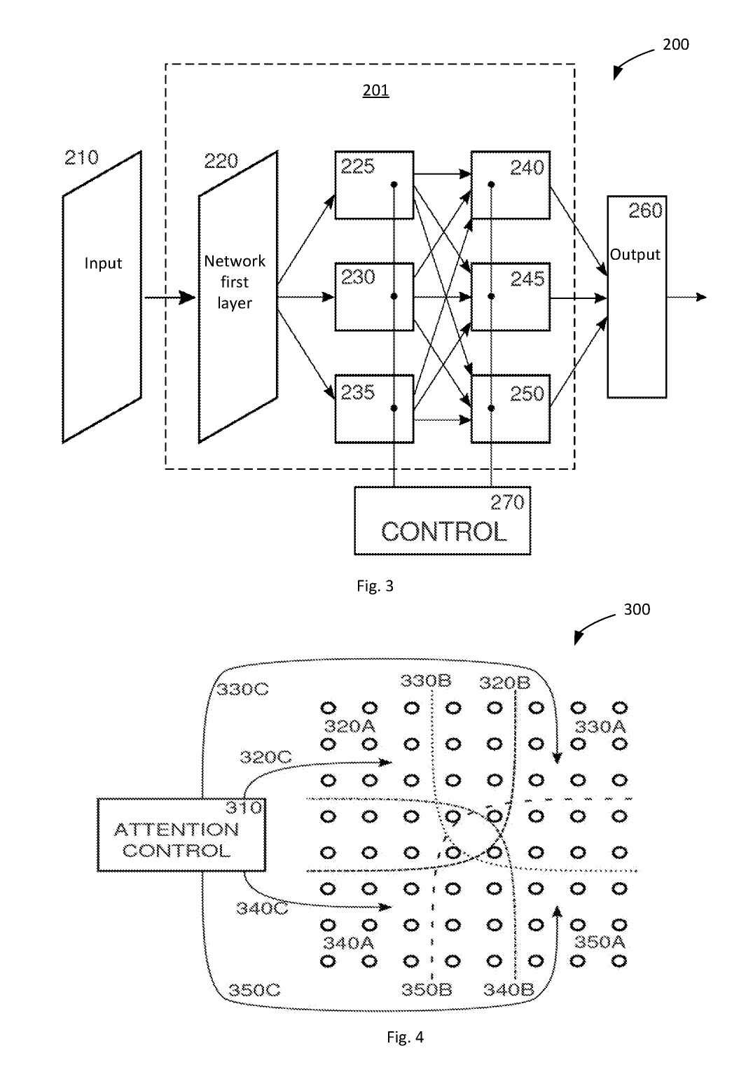

Reference is now made to FIG. 3, which is a schematic illustration of an attention mechanism 200 for controlling a neural network classification engine 201, for example implemented in a recognition engine 12, according to some embodiments of the present invention. Neural network classification engine 201 includes a plurality of network regions 220-250. Each region may include a sub-network trained for classification of images including another condition, object or any other suitable property, for example that may be included in a current environment of a vehicle. Recognition engine 12 may include a control switch 270 that may select on which regions the classification should be focused, e.g. which regions of classification engine 201 should be utilized in a specific classification task. Control switch 270 may receive instructions from attention engine 13 to focus on selected regions and/or amplify sensitivity and/or contribution of selection regions to the operation of classification engine 201.

Some of network regions 220-250 may relate to different options of a certain aspect of the environment, and controller 270 may activate the regions relating to selected classification options, for example according to instructions received from attention engine 13. For example, controller 270 may select one of network regions 225, 230, and 235, for example each relating to a different weather class and/or a visibility condition class, and one of network regions 240, 245, and 250, for example each relating to different classes of pedestrians, for example grown up people, children or old people. Thus, controller 270 and/or attention engine 13 may configure classification engine 201 to classify by relevant combinations of network regions, such as the combination of a current identified weather condition and an expected type of pedestrians in a current environment. Accordingly, some embodiments of the present invention provide an adaptive neural network that can be tuned according properties of a current environment.

It will be appreciated that the disclosed methods of classification and selection of neural network regions is not limited to the examples detailed herein, and other manners of division and/or structuring of the neural network and/or selection of regions is applicable according to some embodiments of the present invention.

Reference is now made to FIG. 4, which is a schematic illustration of a neural network classification engine 300, for example implemented in a recognition engine 12, according to some embodiments of the present invention. Classification engine 300 may include a neural network divided to several neural network regions, such as regions 320A, 330A, 340A and 350A, and an attention controller 310. Attention controller 310 may receive instructions from attention engine 13 to select and/or focus on selected neural network regions, and/or amplify sensitivity and/or contribution of selected neural network regions to the operation of classification engine 300. In FIG. 4, regions 320A, 330A, 340A and 350A are outlined by corresponding lines 320B, 330B, 340B and 350B, respectively. Attention controller 310 may individually control regions 320A, 330A, 340A and 350A by corresponding signal channels 320C, 330C, 340C and 350C, respectively. In some embodiments, in each of neural network regions 320A, 330A, 340A and 350A some of the network nodes are unique to that region and some network nodes are common to more than one of the neural network regions. It will be appreciated that the invention is not limited to any specific number, sizes and structure of network regions and any suitable number sizes and structure of neural network regions are applicable according to some respective embodiments of the present invention. Additionally, in some embodiments the neural network regions may have the same or different sizes.

In some embodiments of the present invention, the neural network may be trained, for example by processing unit 10 or by any other suitable processor, to generate a multi-regional neural network. For example, a neural network may be stimulated to include separated spatial regions in which different kinds of processing is performed, for example so suitable for respective different kinds of input signals and/or classes of object and/or conditions.

According to some embodiments, processor unit 10 may utilize in the training process a special loss function Ls:

$$Ls = {\sum }_{j} ( l ( {p}_{j}^{k} , {a}_{j}^{k} ) + s ( k , j ) )$$

Ls includes a member s(k,j) that depends on, further to the type of the input signal and/or the class of an object and/or a condition, the location of a node in the network, thus favoring spatial separation of neural network to regions. The term l(pⱼ^{k},aⱼ^{k}) is a loss function wherein j is the index of the neural network nodes, aⱼ^{k} is the expected value of classification, pⱼ^{k} is the predicted classification, and k is the index of object class, signal type or of other parameter of the classification.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor, or a portable device such as a smart phone or a tablet computer, or a micro-processor, or a RISC processor, or a DSP, possibly sc comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA or ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A method for implementation of attention mechanism in artificial neural networks, the method comprising:
receiving sensor data from at least one sensor sensing properties of an environment;
classifying the received data by a multi-regional neural network, wherein each region of the network is trained to classify sensor data with a different property of the environment, and wherein each region has an individually adjustable contribution to the classification;
calculating based on the classification a current environment state including at least one property of the environment; and
based on the at least one property, selecting corresponding regions of the network and adjusting contribution of the selected regions to the classification.

2. The method of claim 1, wherein altering contribution of the selected regions is by applying a weight coefficient to an output value of a node of the network, according to a location of the node within the network.

3. The method of claim 1, wherein altering contribution of the selected regions is by activating a region relating to a classification option selected based on the at least one property.

4. The method of claim 1, wherein altering contribution of the selected regions is by configuring the classification to classify by relevant combinations of network regions.

5. The method of claim 1, wherein in each of the neural network regions some of the network nodes are unique to that region and some network nodes are common to more than one of the neural network regions.

6. The method of claim 1, wherein the neural network regions have various sizes and/or structures.

7. The method of claim 1, comprising training the neural network to generate a multi-regional neural network, by a loss function including a member depending on a classification parameter and a location of a network node in the neural network.

8. The method of claim 1, wherein the sensor data comprises at least one of image data, depth data and sound data, and wherein the at least one property is an object and/or a condition of the environment.

9. A system for implementation of attention mechanism in artificial neural networks, the system comprising:
at least one sensor configured to sense properties of an environment; and
a processor configured to carry out code instructions for:
receiving sensor data from the at least one sensor:
classifying the received data by a multi-regional neural network, wherein each region of the network is trained to classify sensor data with a different property of the environment, and wherein each region has an individually adjustable contribution to the classification;
calculating based on the classification of a current environment state including at least one property of the environment; and
based on the at least one property, selecting corresponding regions of the network and adjusting contribution of the selected regions to the classification.

10. The system of claim 9, wherein the processor is configured to alter contribution of the selected regions by applying a weight coefficient to an output value of a node of the network, according to a location of the node within the network.

11. The system of claim 9, wherein the processor is configured to alter contribution of the selected regions by activating a region relating to a classification option selected based on the at least one property.

12. The system of claim 9, wherein the processor is configured to alter contribution of the selected regions by configuring the classification to classify by relevant combinations of network regions.

13. The system of claim 9, wherein in each of the neural network regions some of the network nodes are unique to that region and some network nodes are common to more than one of the neural network regions.

14. The system of claim 9, wherein the neural network regions have various sizes and/or structures.

15. The system of claim 9, wherein the processor is configured to train the neural network to generate a multi-regional neural network, by a loss function including a member depending on a classification parameter and a location of a network node in the neural network.

16. The system of claim 9, wherein the sensor data comprises at least one of image data, depth data and sound data, and wherein the at least one property is an object and/or a condition of the environment.
